(19) United States
(12) Patent Application Publication
(10) Pub. No.: US 2023/0282026 A1
(43) Pub. Date: Sep. 7, 2023

(54) MONITORING PACKAGE PICKUPS USING VIDEO

(71) Applicant: ObjectVideo Labs, LLC, Tysons, VA (US)

(72) Inventors: Donald Gerard Madden, Columbia, MD (US); Ethan Shayne, Clifton Park, NY (US)

(21) Appl. No.: 18/116,081

(22) Filed: Mar. 1, 2023

Related U.S. Application Data
(60) Provisional application No. 63/316,259, filed on Mar. 3, 2022.

(51) Int. Cl. G06V 40/16; G06V 20/52; G06V 20/40; G06Q 10/083

(52) U.S. Cl. CPC G06V 40/172; G06V 20/52; G06V 20/44; G06Q 10/083; G06V 2201/09

(57) ABSTRACT

Methods, systems, and apparatus, including computer programs encoded on computer storage media, for automated package management. One of the methods includes for an image that depicts a package at a property and a person retrieving the package, determining, using data from the image or from a device for the person, whether the person is authorized to retrieve the package; and in response to determining that the person is authorized to retrieve the package, determining to skip performing an automated action that would have been performed if the person was not authorized to retrieve the package.

### CROSS-REFERENCE TO RELATED APPLICATION

This application claims the benefit of U.S. Provisional Application No. 63/316,259, filed Mar. 3, 2022, the contents of which are incorporated by reference herein.

### TECHNICAL FIELD

This disclosure application relates generally to monitoring systems.

### BACKGROUND

Many properties are equipped with monitoring systems that include sensors and connected system components. Monitoring systems can receive and analyze data from sensors that are internal and external from the property. Some monitoring systems include cameras.

Delivery services can pick up packages from one location to deliver to another location. At a residential or commercial property, a person may leave a package for pickup by a delivery service. Packages left out for pickup can be at risk of package theft. Packages can also be at risk of being picked up by the wrong delivery service, e.g., in an example where multiple packages are left at the same location. Cameras can capture images of packages left for pickup, and of people picking up the packages.

### SUMMARY

Techniques are described for monitoring package pickups using video. The disclosed techniques can be used to monitor packages until they are picked up from a property, and to guide delivery services in picking up the proper packages. Packages can be monitored using video analytics performed on video captured by a camera installed at a property. For example, the camera may be a doorbell camera that is installed at a door of a property and that can capture images of a package left for pickup from the property.

In general, one innovative aspect of the subject matter described in this specification can be embodied in methods that include the actions of for an image that depicts a package at a property and a person retrieving the package, determining, using data from the image or from a device for the person, whether the person is authorized to retrieve the package; and in response to determining that the person is authorized to retrieve the package, determining to skip performing an automated action that would have been performed if the person was not authorized to retrieve the package.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some implementations of this aspect, determining, using the data from the image or from the device for the person, whether the person is authorized to retrieve the package includes: determining, using the data form the image, that the person is potentially not authorized to retrieve the package; in response to determining, using the data form the image, that the person is potentially not authorized to retrieve the package, presenting a prompt for the person to provide information indicating that they are authorized to retrieve the package; in response to presenting the prompt for the person, determining a response to the prompt; and determining, using the response to the prompt, whether the person is authorized to retrieve the package.

In some implementations of this aspect, presenting the prompt includes sending an instruction to another device installed at the property to cause the other device to present the prompt; and determining the response to the prompt includes: capturing, with a microphone or a camera, sensor data that indicates the response to the prompt; and analyzing the sensor data to determine the response to the prompt.

In some implementations of this aspect, presenting the prompt includes sending an instruction to the device for the person to cause the device to present the prompt; and determining the response to the prompt includes receiving, from the device for the person, the response to the prompt.

In some implementations of this aspect, presenting the prompt includes presenting the prompt for at least one of a visual credential or a verbal passphrase; and determining the response to the prompt includes receiving sensor data encoding at least one of the visual credential or the verbal passphrase.

In some implementations of this aspect, using the data from the image or from the device for the person, whether the person is authorized to retrieve the package includes: recognizing, using the data from the image, an identifying mark on the person or a vehicle for the person came; and in response to recognizing the identifying mark on the person or a vehicle for the person came, determining that the person is authorized to retrieve the package.

In some implementations of this aspect, the identifying mark includes at least one of a uniform, a logo, a company name, or a badge.

In some implementations of this aspect, determining, using the data from the image or from the device for the person, whether the person is authorized to retrieve the package includes: in response to detecting a depiction of the person in the image, sending, to the device for the person, a request for data relating to an authorization of the person retrieving the package; and determining, using a response or an indication that no response was received, whether the person is authorized to retrieve the package.

In some implementations of this aspect, the device for the person includes a pickup vehicle, a handheld device, or a badge for the person.

In some implementations of this aspect, determining, using the data from the image or from the device for the person, whether the person is authorized to retrieve the package includes determining, using a) package data for the package and b) the data from the image or from the device for the person, whether the person is authorized to retrieve the package.

In some implementations of this aspect, determining, using the data from the image or from the device for the person, whether the person is authorized to retrieve the package uses security data for the package.

In some implementations of this aspect, determining to skip performing the automated action that would have been performed if the person was not authorized to retrieve the package includes determining to skip one or more confirmation actions to increase a confidence that the person was not authorized to retrieve the package.

In some implementations of this aspect, determining to skip the one or more confirmation actions includes determining to skip sending a message to a device for an authorized person that prompts the authorized person to perform an action.

In some implementations of this aspect, determining, using data from the image or from a device for the person, whether the person is authorized to retrieve the package includes: determining, using the data from the image or from the device for the person, a confidence level that indicates a likelihood that the person is authorized to retrieve the package; and determining whether the confidence level satisfies a confidence threshold.

Some implementations of this aspect include determining, using data from a second image or from a device for the person, whether the person will likely retrieve the correct package; and in response to determining that the person will likely retrieve the correct package, determining to skip performing an automated action that would have been performed if the person retrieved the incorrect package. The foregoing and other implementations can each optionally include one or more of the following features, alone or in combination.

The subject matter described in this specification can be implemented in various implementations and may result in one or more of the following advantages. In some implementations, the subject matter can provide a user with the ability to observe packages before pickup or after delivery for security reasons. In some implementations, the user can receive updates at pickup or delivery of a package. In some implementations, the systems and methods described in this specification can reduce a number of actions performed, e.g., when a person is authorized to pick up a package, compared to other systems. This can reduce computational resource usage. In some implementations, the systems and methods described in this specification can generate alerts only when a likely unauthorized person retrieves a package, e.g., improving security. In some implementations, the systems and methods described in this specification can prevent confusion, errors, or both, during unattended package pickup; can increase efficiency for the shipping company; can reduce the amount of burden on the consumer to manage such pickups; or a combination of two or more of these.

The details of one or more implementations of the subject matter described in this specification are set forth in the accompanying drawings and the description below. Other features, aspects, and advantages of the subject matter will become apparent from the description and the drawings.

### BRIEF DESCRIPTION OF THE DRAWINGS

FIG. 1 illustrates an example system for verifying package pickups by authorized personnel using video.

FIG. 2 illustrates an example system for guarding packages from pickup by unauthorized personnel using video.

FIG. 3 is a flow diagram of an example process for verifying package pickups by authorized personnel.

FIG. 4 is a flow diagram of an example process for guarding packages from pickup by unauthorized personnel.

FIG. 5 is a diagram illustrating an example of a monitoring system.

Like reference numbers and designations in the various drawings indicate like elements.

### DETAILED DESCRIPTION

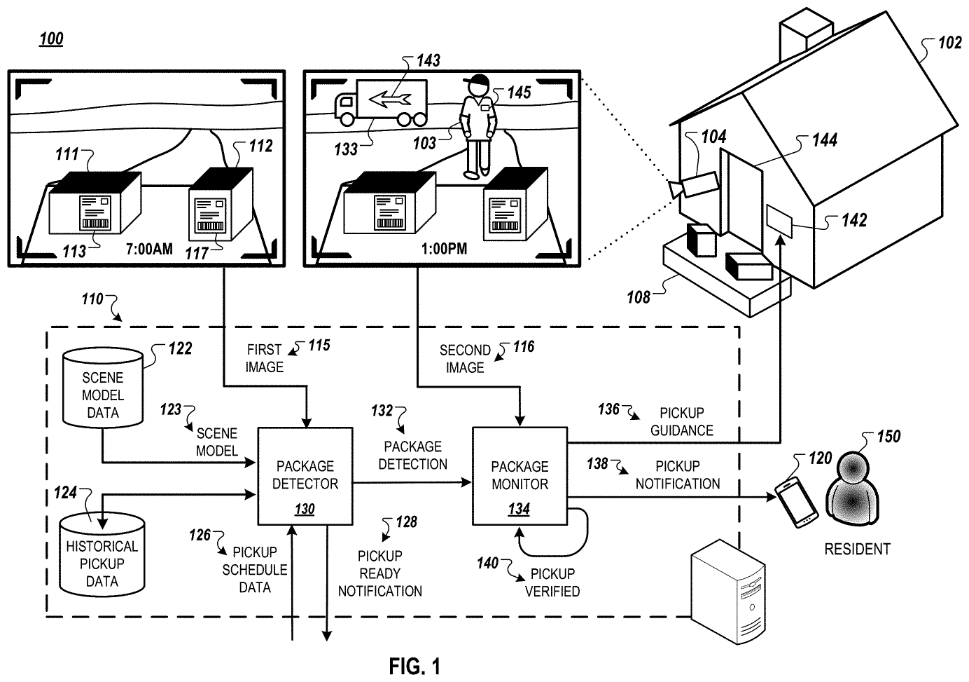

FIG. 1 is a diagram illustrating an example environment 100 in which monitoring system 110 can verify package pickups by authorized personnel using video. The monitoring system 110 can include a camera 104 installed at a property 102, and a monitoring system 110. The property 102 can be a home, another residence, a place of business, a public space, or another facility that is monitored by a monitoring system.

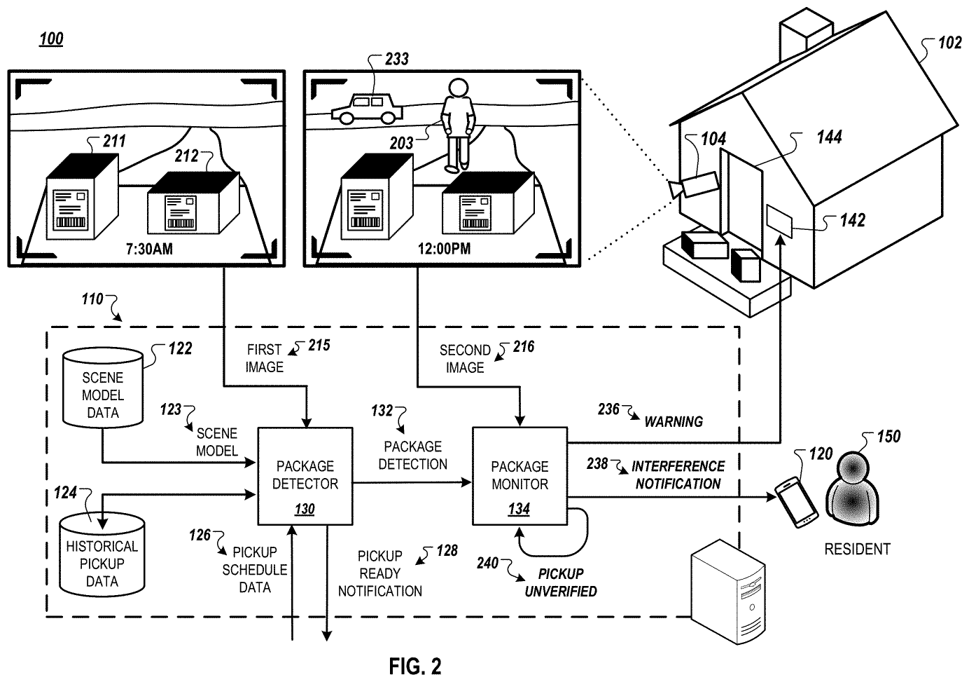

In general, the camera 104 captures images of a package left for pickup at the property 102. The package detector 130 of the monitoring system 110 detects the package, and the monitoring system 110 monitors the package using the camera 104 until the package is picked up. When a person arrives to pick up the package, the package monitor 134 of the monitoring system 110 verifies that the person is authorized to pick up the package. If the person is authorized to pick up the package, the monitoring system can provide pickup guidance 136 and provide a pickup notification 138 to a resident 150. Referring to FIG. 2, if the person is not authorized to pick up the package, the monitoring system 110 can provide a warning 236, provide an interference notification 238 to the resident 150, and/or perform other actions to deter the person from picking up the package.

The resident 150 is associated with a mobile device 120. The mobile device 120 can be, for example, a smart phone or tablet computer. The mobile device 120 each includes a communication module for communicating over one or more wireless networks. For example, the mobile device 120 can connect to the internet using a cellular or Wi-Fi network. The mobile device 120 can communicate wirelessly with, for example, a GPS satellite system, the monitoring system 110, the camera 104, and other computing devices. The mobile device 120 can communicate with each other, e.g., by SMS message, email, telephone call, or through a mobile application.

The camera 104 can be, for example, a surveillance camera installed at the property 102. The camera 104 is installed external from the property 102. The camera 104 is installed near a door 144. However, the camera 104 may instead be installed internal from the property 102. For example, the camera 104 may be inside the property 102 next to a window facing outwards with a view of a yard of the property 102.

The camera 104 can be a component of a monitoring system, e.g., a doorbell camera. In some examples, the camera 104 can be configured to record continuously. In some examples, the camera 104 can be configured to record at designated times, such as on demand, when triggered by another sensor of the monitoring system, or when triggered by detection of object motion within a field of view of the camera 104.

The camera 104 can capture visual images of scenes at the property within a field of view of the camera 104. The camera 104 can perform video analysis on captured images. Video analysis can include, for example, event detection, object detection, and object classification. In some examples, the camera 104 can send image data to a computing system, e.g., a monitoring system 110, and the monitoring system 110 can perform video analysis on the captured images. In some examples, the camera 104 and the monitoring system 110 can each perform video analysis on the captured images. For example, the camera 104 can perform object detection, while the monitoring system 110 can perform object classification.

To support communications with the monitoring system 110, the camera 104 can include a communications module, such as a modem, transceiver, modulator, or other hardware or software configured to enable the camera 104 to communicate electronic data to the monitoring system 110. The camera 104 can send data to the monitoring system 110 over a long-range data link. The long-range data link can include any combination of wired and wireless data networks. For example, the monitoring system 110 can exchange information with the camera 104 through a wide-area-network (WAN), a broadband internet connection, a cellular telephony network, a wireless data network, a cable connection, a digital subscriber line (DSL), a satellite connection, or other electronic means for data transmission. In some implementations, the long-range data link between the monitoring system 110 and the camera 104 is a secure data link (e.g., a virtual private network) such that the data exchanged between the monitoring system 110 and the camera 104 is encoded to protect against interception by an adverse third party.

The monitoring system 110 can be, for example, a remote monitoring system of the monitoring system 110. The monitoring system 110 can include one or more computer systems, server systems, or other computing devices that are located remotely from the property 102 and that are configured to process information related to the monitoring system at the property 102. In some examples, the monitoring system 110 is a cloud computing platform. Although the monitoring system 110 shown in FIG. 1 receives image data from one camera installed at the property 102, the monitoring system 110 can receive image data from any number of cameras at the property 102 and can receive image data from cameras at any number of properties.

FIG. 1 illustrates packages 111, 112 that have been left for pickup from the property 102. The packages 111, 112 can be, for example, packages to be returned by the resident 150 to a retailer using a package delivery service. In some examples, the package 111 can be a package for delivery from the resident 150 to another person, such as a box of gifts or purchases to be sent through a mail service.

When leaving a package for pickup, the resident 150 can place the package in view of the camera 104. In some examples, the monitoring system 110 can perform a recognition process for recognizing the resident 150. For example, the monitoring system 110 can perform facial recognition of the resident 150 using images captured by the camera 104. In some examples, the monitoring system 110 can store profiles of people associated with the property 102. For example, the monitoring system 110 can store profiles of residents of the property 102, of regular guests at the property, of delivery people who frequently deliver packages and mail to the property, etc. When a person is in the field of view of the camera 104, the monitoring system 110 can perform a recognition process to determine if the person matches any of the stored profiles.

The monitoring system 110 can also perform image analysis to recognize objects such as boxes and envelopes. In some examples, the monitoring system 110 can store a database of images of various types of packages. Based on determining that features of an object in the field of view of the camera 104 match features of a stored image of a package, the monitoring system 110 can determine that a package has been left for pickup.

In the example of FIG. 1, the package detector 130 obtains image 115 from the camera 104. The image 115 shows the packages 111, 112 on the porch 108 from the perspective of the camera 104. The package detector 130 detects the packages 111, 112 in the first image 115. The first image 115 is captured at 7:00 am.

The image 115 can be an image captured by the camera 104 and generated from any appropriate type of light. For example, the images can be generated from any combination of visible light, IR light, or UV light. The images can also be generated from RADAR, LIDAR, and/or microwave imaging. The image 115 can include any combination of still images, recorded video, or live-streamed video.

Although FIG. 1 shows a single camera 104, there may be multiple cameras installed at the property 102. The monitoring system 110 can obtain images from, e.g., outdoor cameras, doorbell cameras, and indoor cameras. The monitoring system 110 can also obtain additional monitoring system information from the property 102. The monitoring system 110 can obtain the monitoring system information from sensors at the property 102, from a monitoring system control unit at the property 102, or any combination of these. The monitoring system information can include, for example, data indicating an open or shut status of a door, data indicating a locked or unlocked status of a door, data indicating when a doorbell was pressed, data indicating occupancy of the property 102, data indicating an arming status of the property 102, etc.

In some examples, the monitoring system 110 can obtain image analysis data from the camera 104. For example, the camera 104 or a computing system in electrical communication with the camera 104 can perform video analysis on images captured by the camera 104 and transmit video analysis results to the monitoring system 110. The camera 104 can perform video analysis including, e.g., human detection, recognition, and tracking, object detection, recognition, and tracking, background change detection, event detection, etc. The camera 104 can send the results of the video analysis to the monitoring system 110. For example, when a person leaves a package on the porch 108 for pickup, the camera 104 can perform video analysis to track the person placing the package, detect the package placed on the ground within the camera field of view, and estimate an outline of the package based on a region of pixels that have changed compared to the background. In some examples, the camera 104, the monitoring system 110, or both, can employ an object detection and/or scene segmentation network for detecting and tracking packages.

In some examples, the monitoring system 110 includes a signaling device 142. The signaling device can include communication devices and sensors. For example, the signaling device 142 can include a microphone, audio speaker, light, and/or display panel. The signaling device 142 can be in electrical communication with the monitoring system 110, the camera 104, or both.

When the resident 150 places the packages 111, 112 on the porch 108, the monitoring system 110 can transmit instructions to the signaling device 142 that causes the signaling device 142 to communicate with the resident 150 through the communication devices. For example, the signaling device 142 can communicate with the resident 150 by broadcasting audio through a speaker. The audio can include verbal audio stating, for example “are you dropping off a package?” The resident can confirm that the resident is dropping off a package, e.g., with a verbal response that can be detected by the microphone, with a visual response that can be detected by the camera 104, or both. For example, the resident can speak the word “yes” or hold up the package to the camera 104.

In some cases, the system can determine that a response was not received either through an elapsed period of time with no response, through other means, or a combination of both. The determined lack of response can trigger actions by the system. For example, a prompt from the system can request identification or verification from a resident or the person picking up the package. If no response is received, e.g., the person fails to identify themselves, the system can alert the resident of a possible unauthorized pickup or drop off.

The package 111 has a shipping label 113 and the package 112 has a shipping label 117. The shipping labels 113, 117 can include information about the packages 111, 112. The information can be presented as text of the shipping labels and/or through bar codes or QR codes of the shipping labels.

The camera 104 can capture an image of the shipping labels 113, 117 to obtain information about the packages 111, 112. In some examples, the camera 104 can zoom in on the shipping labels 113, 117 to read the shipping labels. In some examples, the camera 104 can capture an image of the shipping labels 113, 117 when the resident holds the packages 111, 112 up to the camera 104. In some examples, the monitoring system 110 can prompt the resident to hold the packages 111, 112 up to the camera 104 prior to leaving the packages 111, 112 for delivery. For example, the monitoring system 110 can communicate with the resident through the signaling device 142 to instruct the resident to hold the packages 111, 112 up to the camera 104. The monitoring system 110 can provide instructions, e.g., through verbal instructions broadcast from a speaker, through textual instructions presented on a display, or both.

In some examples, the resident 150 can register the packages 111, 112 with the monitoring system 110 using an application of a computing device such as the mobile device 120. For example, prior to placing the packages 111, 112 on the porch 108, the resident 150 can scan the shipping labels 113, 117 of the packages 111, 112 using a camera of the mobile device 120. An application of the mobile device 120 can provide the information from the shipping labels 113, 117 to the monitoring system 110. The information can include pickup schedule data 126. The pickup schedule data 126 for the package 111 can include data indicating information such as a pickup service that is assigned to pick up the package 111, an expected time of pickup, a description of the package 111, and a destination of the package 111. In some examples, the pickup schedule data 126 can include a name of an assigned pickup person, an image of the pickup person's face, a license plate number of a pickup vehicle, and/or other identifiable information for the assigned pickup person.

The package detector 130 can read the shipping labels 113, 117 to obtain information about the packages 111, 112. For example, the package detector 130 can include a barcode reader for reading barcodes on shipping labels and/or a text reader for reading text from shipping labels. The package detector 130 can obtain information about the package 111 from the shipping label 113, such as which delivery service is to pick up the package 111 and an expected pickup time.

In some examples, in addition to or instead of reading the shipping labels 113, 117, the package detector 130 can obtain information about the packages 111, 112 from the resident. For example, the resident can speak to the signaling device 142 when dropping off the packages 111 to state that the package 111 is being left for pickup. The resident can also verbally state which delivery service is to pick up the package 111 and/or a time of pickup. As an example, the resident can state “for pickup by UPS at 1:00 pm.” The resident's speech can be detected by the microphone of the signaling device and interpreted by the monitoring system 110.

In some examples, in addition to or instead of reading the shipping labels 113, 117, the package detector 130 can obtain information about the packages 111, 112 from the delivery service. For example, the delivery service can provide pickup schedule data 126 to the resident 150 through electronic communications such as email and SMS message. In some examples, the mobile device 120 can receive the pickup schedule data 126 and the mobile device 120 can forward the pickup schedule data 126 to the monitoring system 110. In some examples, the pickup schedule data 126 can be sent to a proxy address that forwards the information to the monitoring system 110. In some examples, the monitoring system 110 can intercept the pickup schedule data 126, e.g., the resident 150 can opt-in through a mobile application to permissions that enable the monitoring system 110 to read pickup information notifications transmitted to the mobile device 120.

In some examples, the monitoring system 110 can generate the shipping labels 113, 117 or can be integrated with a different system that generated the shipping labels 113, 117. For example, the monitoring system 110 can include components that are operated and/or serviced by a home security enterprise. Example components can include, for example, motion sensor devices, microphones, cameras, and window sensors. The resident 150 may submit a request to return a defective component to the home security enterprise for repair or replacement. Upon approval of the request, the monitoring system 110 can generate a shipping label for the resident 150 to use to return the defective component.

In some cases, the home security enterprise can send a pre-labeled box to the resident 150. The label, the box, or both can include a visual identifier, such that when the camera 104 detects the visual identifier, the monitoring system 110 can determine that the defective component has been left for pickup. In some cases, the home security enterprise can send instructions to the resident 150 to place the defective component, unboxed, on the porch 108 for pickup. The camera 104 can detect and identify the defective component when the defective component is within the field of view of the camera 104, e.g., by comparing the image of the defective component to a stored model of the defective component. The monitoring system 110 can then generate a pickup ready notification 128 that notifies a pickup person that the defective component is ready for pickup.

In some examples, the resident 150 can set security levels for each package that is left for pickup. For example, the package 111 may contain an expensive item that is to be picked up by a delivery service. The package 112 may contain items to be donated to a charity. The resident 150 may desire to set higher security levels for the package 111 and lower security levels for the package 112. The resident 150 can set security levels when leaving the packages 111, 112, for pickup or when registering the packages 111, 112 with the monitoring system 110. For example, through an application of the mobile device 120, the resident 150 can capture an image of the package 111 using a camera of the mobile device 120 and set the security settings for the package 111 to “high.” The resident 150 can capture an image of the package 112 using the camera of the mobile device 120 and set the security settings for the package 112 to “low.” In some cases, the resident can verbally indicate security settings for the packages 111, 112 when setting the packages 111, 112 on the porch 108. For example, the resident 150 can hold the package 111 in view of the camera 104 and say “high security.” The resident 150 can hold the package 112 in view of the camera 104 and say “low security.” The resident's speech can be detected by the microphone of the signaling device 142 and interpreted using speech-to-text technology.

The monitoring system 110 can monitor the packages 111, 112 based on the security settings for each package. For example, for package 111, with a high security setting, the monitoring system 110 may require a person to provide multiple types of credentials before picking up the package 111. For package 112, with a low security setting, the monitoring system 110 might not require a person to provide any credentials before picking up the package 112. For a package with a medium or intermediate security setting, the monitoring system 110 may require a person to provide at least one credential before picking up the package. Various types of credentials and verifications that can be performed by the package monitor 134 are described in greater detail below.

In some examples, the resident 150 can set out multiple packages for pickup by different services. If one package occludes another package from view of the camera 104, the monitoring system 110 can provide instructions to the resident 150 to move the packages so that they are all viewable by the camera 104. Similarly, in some cases, the resident 150 may place a package outside of a field of view of the camera 104. The monitoring system 110 can provide instructions to the resident 150 to move the package to a location that is inside the field of view of the camera 104.

In some examples, the resident 150 or any other user or person, or any combination of people to include the resident 150 can set out multiple packages for pickup by different services. The different services can have different deliveries scheduled at the property 102. The monitoring system 110 can utilize camera 104 and other sensors throughout the property 102, to coordinate the pickup and deliveries from the multiple different services. For example, if a delivery person places the newly delivered package on top of a package to be picked up, or if the delivery person turned to leave without picking up a package for their retrieval, the monitoring system 110 might remind the delivery person that a package is out for pickup. In the former instance, the reminder can cause the person to place the newly delivered package somewhere that is not on top of a package to be picked up. In the latter instance, the reminder can cause the person to retrieve the package. In some examples, the monitoring system 110 can guide the delivery services to place packages in different physical areas that can represent pickup and drop off for respective services.

In some examples, the monitoring system 110 can direct the pickup and drop off of packages through multiple presentation devices such as auditory prompts, displayed images, messages sent to the delivery person's device, visual prompts, or a combination of these. For example, the monitoring system 110 can outline an area on the front porch with a laser grid such that the delivery person knows where to drop off a package. The monitoring system 110 can project a laser onto a second package that is meant for pickup. The monitoring system 110 can send a message alert to the delivery person's mobile device that can include information about the package to be picked up.

In some examples, the monitoring system 110 can process visual information about the packages in order to track the multiple packages. The monitoring system 110 can track shape, color, size, identifying features, logos, or a combination of these from the packages and can identify key features of the environment such as patio furniture, plants, lights, or other more temporary objects such as bags, toys, coolers, or more. The visual tracking of the packages and the environment can provide for more accuracy in determining the number of packages for pickup and drop off compared to other systems. For example, the monitoring system 110 can prompt a delivery person to leave the package on the brown chair by providing an audio prompt such as “Please leave the package on the brown chair.” In some implementations, the monitoring system 110 can turn on a light illuminating the brown chair if, for example, the delivery were occurring in low light conditions. The monitoring system 110 can utilize the environment and the number of packages to coordinate the pickup and drop off

The monitoring system 110 can track packages for drop off and pickup. For example, in areas where there is not enough space and packages may be stacked upon one another, the monitoring system 110 can keep track of the stacks of packages. For instance, the monitoring system 110 can present a notification that indicates that a delivery person should retrieve the third package from the bottom of a pile and place a package for delivery on the top of the pile.

The monitoring system 110 can track the multiple packages for pickup and drop off from the multiple services and send alerts to the resident 150 or any combination of users. For example, a user can be alerted through a text message that a package was picked up, that two more packages remain to be picked up, and that one package was delivered.

The scene model database 122 stores a spatial model of one or more scenes where packages may be left for pickup at the property 102. For example, the scene model database 122 can store a model of a scene or scenes including the porch 108. In some examples, the scene model database 122 can build the scene model 123 using images captured by multiple installed cameras with overlapping field of view, e.g., the camera 104 and any other cameras at the property that have a field of view that includes the porch 108. Geometric relationships between the multiple cameras can be stored by the monitoring system 110. The geometric relationships can be determined using image analysis, based on programmed installation positions of the cameras, or both. In some examples, the scene model database 122 can store spatial models of scenes at multiple properties.

In some examples, the scene model 123 can be developed during a training or setup phase of the monitoring system. For example, a user can perform a survey by using a camera, e.g., a camera that is part of a mobile device, to capture video or still images of scenes at the property 102 where packages are likely to be left for pickup. The user can provide the captured images to the monitoring system 110. The monitoring system can store the captured images in the scene model database 122 and can use the captured images to build the scene model 123.

In some examples, the scene model database 122 can generate, build, or improve the scene model 123 over time. The scene model database 122 can build the model of the scene using images captured by the camera 104 and by any other cameras installed at the property 102.

The scene model database 122 can store data indicating an estimation of the relative orientation of the ground plane including pixels of images captured by the camera 104 that correspond to the ground. The monitoring system 110 can learn which pixels correspond to the ground, e.g., using machine learning methods. The monitoring system 110 can analyze images captured by the camera 104 showing people, animals, and vehicles traversing over the ground. Based on analyzing the images, the monitoring system 110 can identify the ground plane. Identifying the ground plane can enable the monitoring system 110 to estimate the planar geometry of the scene. For example, the monitoring system 110 can assume that the porch 108 is part of the ground plane of the scene and has a planar shape.

In some examples, the package detector 130 can compare the first image 115 to the scene model 123 to determine if any packages have been left for pickup. In some examples, the package detector 130 can select a version of the scene model 123 based on environmental conditions at the property 102. For example, the scene model database 122 can store scene models that represent the scene at various times of day, seasons of year, precipitation conditions, etc. The package detector 130 can select a particular version of the scene model 123 that most closely matches the current date, time, and/or weather conditions. In some examples, the scene model database 122 can store scene models for multiple properties, and the package detector 130 can select the scene model 123 for the particular property 102.

The package detector 130 can detect that the packages 111, 112 have been left on the porch 108 for pickup based on comparing the first image 115 to the scene model 123. In some examples, the package detector 130 can perform package detection based at least in part on historical pickup data. For example, a historical pickup database 124 can store data indicating historical package pickup times and locations. The historical package pickup times and locations can be determined, for example, based on historical camera image data and user feedback.

In some examples, the historical pickup database 124 can store a data entry for each past pickup, with each entry including a time of the pickup and a location of the pickup. The location of the pickup can be, for example, the porch 108, a driveway, a back door, or another location at the property from where a package can be picked up.

In some implementations, upon installation, the monitoring system 110 may have a training phase. The training phase can be used to generate scene model data for storage in the scene model database 122, historical pickup data for storage in the historical pickup database 124, or both.

In some examples, the training phase may be a period of multiple days or weeks. During the training phase, the monitoring system 110 can obtain images of all package pickups from the property 102. The monitoring system 110 can store images of pickup personnel and times of the pickups. The monitoring system 110 can also store locations of packages that are left for pickup during the training phase. For example, packages may be left for pickup at the porch 108, at a back door, or at a garage door of the property 102. In some examples, in addition to or instead of the training phase, the camera 104 and the monitoring system 110 can continuously record and store pickup times, personnel, and locations while in operation. The monitoring system 110 can analyze all pickups, or a selection of pickups. In some examples, the monitoring system 110 can use electronic pickup notifications received from delivery services as ground truth labeling for the training data.

In some examples, based on detecting the packages left for pickup, the package detector 130 can output a pickup ready notification 128. The pickup ready notification 128 can include a message that the package 111 is ready for pickup. The pickup ready notification 128 can include additional information about the package 111, such as information related to the appearance of the package 111 and the location where the package 111 has been placed. For example, the pickup ready notification 128 can include a close-up image of the package 111, a picture of the package 111 after it was placed on the porch 108, a diagram showing where in the scene the package 111 is located, a text description of the package 111 inferred from the first image 115, and/or a text description of where the package 111 was placed (e.g., “behind the white chair”).

The pickup ready notification 128 can be sent to the assigned pickup delivery service for the package 111, as indicated by the shipping label 113 or other package registration information. In some examples, the pickup ready notification 128 can be sent to the resident 150. The pickup ready notification 128 can serve as confirmation to the resident 150 that the monitoring system 110 did correctly detect and identify the package 111. The pickup ready notification 128 can also flag to the resident 150 if an object has been unintentionally left on the porch 108, e.g., in a scenario in which the resident 150 receives a pickup ready notification 128 but has not placed a package on the porch 108 for delivery.

In some examples, the pickup ready notification 128 can include verification information that can be used to verify that the person picking up the package 111 is authorized to pick up the package 111. For example, the package detector 130 can generate a credential such a password or bar code for the package 111. The credential can be provided to the delivery service and/or to the assigned pickup person. When the pickup person arrives to pick up the package 111, the pickup person can provide the credential to the monitoring system 110 through the camera 104 or the signaling device 142. In some examples, the monitoring system 110 can provide an API or application that enables the pickup person to use a smartphone or other computing device to authenticate at the time of arrival. The monitoring system 110 can use the credential and/or authentication to verify that the pickup person is authorized to pick up the package 111.

The package detector 130 outputs data indicating package detection 132 to the package monitor 134. The data indicating the package detection 132 can include, for example, identifying information for the package 111 such as a description of the package 111 and a location of the package 111. The data indicating the package detection 132 can also include credential information for the package 111. The credential information can include, for example, a delivery service that is expected to pick up the package 111, a name of a person that is expected to pick up the package, a password, or a bar code. In some examples, the credential information includes an image of the authorized pickup person or biometric information for the authorized pickup person. The biometric information can be used to authenticate the pickup person, and can be deleted after authentication. The package monitor 134 monitors the package 111 using images captured by the camera 104.

The package monitor 134 obtains second image 116 from the camera 104. The image 116 includes a depiction of a truck 133. The second image 116 is captured at 1:00 pm. The image 116 also includes a depiction of a pickup person 103 approaching the porch 108. The pickup person 103 may be an employee or contractor of a delivery service organization. The delivery service organization can be, for example, an internet sales company, a shipping company, or a postal service. The pickup person 103 is a person assigned to pick up the package 111 from the property 102 and to deliver the package 111 to another location.

The package monitor 134 detects the pickup person 103 in the second image 116. The package monitor 134 can perform a verification process to verify 140 that the pickup person 103 is authorized to pick up the package 111.

The verification process can include performing image analysis on the second image 116. For example, the package monitor 134 can analyze the second image 116 to identify a business logo 143 or business name on the truck 133 or on a uniform of the pickup person 103. The package monitor 134 can verify that the business represented by the name or logo 143 matches the delivery service that is assigned to pick up the package 111, as specified in the pickup schedule data 126.

The package monitor 134 can perform verification 140 based on the uniform, vehicle, or badge of the pickup person 103. In some examples, the package monitor 134 can use an encrypted electronic verification between the camera 104 and the delivery vehicle, handheld device (e.g., a cellphone, PDA, mobile telecommunications device), or badge of the pickup person 103. The verification information can be logged along with video of the package being picked up.

In some examples, the package monitor 134 can analyze the second image 116 to read a nametag 145 of the pickup person 103. The package monitor 134 can verify that the name on the nametag 145 matches the name of the assigned pickup person, as specified in the pickup schedule data 126. In some examples, the package monitor 134 can perform facial recognition on the second image 116 to verify that the face of the pickup person 103 matches the face of the assigned pickup person, as specified in the pickup schedule data 126.

In some examples, the delivery person can be prompted to present a visual credential (ID, QR code, pickup receipt, etc.) or verbal passphrase. In some examples, the pickup person 103 can provide a password or an electronic credential to the monitoring system 110, e.g., through the camera 104 of the signaling device 142. For example, the pickup person 103 can present a QR code to the camera 104. The QR code can be, for example, a QR code that matches the QR code on the shipping label of the package 111, or a QR code that was provided to the delivery service as part of the pickup ready notification 128. In some examples, the pickup person 103 can speak a password into the microphone of the signaling device 142. The package monitor 134 can verify that the password matches a password that was provided as part of the pickup ready notification 128.

In some examples, the monitoring system 110 can instruct the pickup person 103, through the signaling device 142, to present the package to the camera for verification. For example, the package monitor 134 can provide pickup guidance 136 that instructs the pickup person 103 to lift the intended package up to the camera 104 before departing with the package. If the pickup person 103 picks up the package 112 instead of the package 111, the monitoring system 110 can inform the pickup person 103 that he or she has picked up the incorrect package. The monitoring system 110 can inform the pickup person 103 of the incorrect package, e.g., by illuminating a red light, by displaying text stating “wrong package,” by broadcasting an audible warning sound, by broadcasting verbal guidance, or through other means.

In some examples, the package monitor 134 can perform pickup verification 140 based on the time of pickup. For example, the pickup schedule data 126 can include data indicating that a first pickup from the USPS is expected between 11 am and 2 pm and that a second pickup from FedEx is expected between 3 pm and 5 pm. The second image 116 is captured at 1:00 pm. The package monitor 134 can therefore determine, based on the pickup schedule data 126 and the timestamps of the second image 116, that the pickup person 103 approaching the property 102 is likely executing the first pickup from the USPS. The package monitor 134 can thus perform verification, e.g., by verifying that the truck 133 has a USPS logo and/or by verifying that the pickup person 103 is wearing a USPS uniform.

In some examples, a package may be left for pickup by a person who is not associated with a delivery service. For example, the resident 150 may leave the package 112 for pickup by a friend named “James.” When the resident 150 places the package 112 on the porch 108, the resident 150 can provide input to the monitoring system 110 indicating that the package 112 is to be picked up by James. For example, the resident 150 can hold the package 112 in the field of view of the camera 104, and can speak words such as “package for James.” In another example, the word “James” may be written on the package.

In some examples, when the resident 150 leaves the package for James, the resident 150 can provide information about James to the monitoring system 110. For example, the resident 150 can provide a phone number for James, an email address for James, and/or an image of James to the monitoring system 110. The resident 150 can provide information about James, for example, by holding information about James up to the camera 104, uploading information about James through a mobile application, or submitting information about James by text or email.

In some examples, based on the package being left for James, the monitoring system 110 can access a stored profile for James. The profile may include an image of James that was previously provided or captured during a previous visit.

When James arrives to pick up the package 112, the package monitor 134 can perform a verification process to verify that the person is James, and can perform actions to ensure that James picks up the correct package. In some examples, the camera 104 can capture an image of James as he approaches the property 102, and the package monitor 134 can compare the captured image to a stored image of James. If the captured image matches the stored image of James according to similarity criteria, the package monitor 134 can determine that person approaching the property is James.

In some examples, in addition to or instead of verifying James' identity based captured images, the package monitor 134 can verify James' identity by other means. For example, as James approaches the property 102, the monitoring system 110 can broadcast an inquiry through a speaker of the signaling device 142. The inquiry can include spoken text such as “please state your name.” James can verify his identity by speaking the word “James.” In some examples, when the resident 150 leaves the package 112 for James, the monitoring system 110 can generate a code such as a QR code or password and transmit the code to the mobile device 120 of the resident 150. The resident 150 can then forward the code to James, e.g., by SMS message or email. When James arrives at the property 102, James can present the code to the camera 104 or to the signaling device. For example, James can hold a QR code up to the camera 104 or can speak a password into a microphone of the signaling device 142. The package monitor 134 can verify James' identity based on the provided code, and permit James to pick up the package 112.

In some examples, the monitoring system 110 can communicate directly with the pickup person, e.g., based on information provided by the resident 150 and/or by a delivery service. For example, the resident 150 can provide James' phone number to the monitoring system 110. The monitoring system 110 can then transmit the pickup ready notification 128 to James via a text message sent to James' phone number. The monitoring system 110 can send also send authentication information to James. For example, the monitoring system 110 can send James a link to an authentication URL or application, etc. In some examples, upon detecting a pickup person in an image captured by the camera 104, the monitoring system 110 can transmit a confirmation message to James. James can then confirm or deny that James is the person who is approaching the property 102, e.g., by responding to the confirmation message.

In some examples, the package monitor 134 can verify 140 the pickup person 103 based on determining that the pickup person 103 satisfies at least one verification criterion, e.g., that a uniform of the pickup person 103 matches a uniform of the delivery service that is assigned to pick up the package 111. In some examples, the package monitor 134 can verify 140 the pickup person 103 based on determining that the pickup person 103 satisfies a coincidence of two or more verification criteria, e.g., that a uniform of the pickup person 103 matches a uniform of the assigned delivery service, and that a name on the nametag 145 matches the name of the assigned pickup person.

In some examples, the package monitor 134 can determine a confidence value representing a confidence that the pickup person 103 is authorized to pick up the package 111. The confidence value can be based on a number of credentials verified for the pickup person 103. For example, the package monitor 134 may determine that the pickup person 103 satisfies five verification criteria: the pickup person 103 is arriving within the expected pickup time window, the logo 143 on the truck 133 matches the assigned delivery service, the pickup person's uniform matches the assigned delivery service, the name on the nametag 145 matches the name of the assigned pickup person, and the pickup person 103 provides an accurate password. Based on determining that the pickup person 103 satisfies five verification criteria, the package monitor 134 can determine a high confidence value, e.g., 90%, that the pickup person 103 is authorized to pick up the package 111.

In another example, the package monitor 134 may determine that the pickup person 103 satisfies only three verification criteria. Based on determining that the pickup person 103 satisfies three verification criteria, the package monitor 134 can determine a lower confidence value, e.g., 70%, that the pickup person 103 is authorized to pick up the package 111.

The package monitor 134 can determine that the pickup person 103 is verified 140 based on determining that the confidence value is at least a specified threshold confidence value. For example, a threshold confidence value may be 50%. Based on determining that the confidence value is the threshold confidence value or greater, the package monitor 134 can determine that the pickup person 103 is verified 140.

Based on verifying that the pickup person 103 is authorized to pick up a package, the package monitor 134 can provide pickup guidance to the pickup person 103 through the signaling device 142.

In some examples, the package monitor 134 can provide the pickup guidance 136 independent of any actions taken by the pickup person 103. For example, upon verifying that the pickup person 103 is authorized to pick up the package 111, the package monitor 134 can provide pickup guidance 136.

In some examples, the package monitor 134 can provide pickup guidance 136 based on actions performed by the pickup person 103. For example, if the camera 104 detects that the pickup person 103 lingers on the porch 108 for greater than a specified threshold period of time, the package monitor 134 can provide pickup guidance 136 to assist the pickup person with finding the package 111. In another example, if the camera 104 detects that the pickup person 103 reaches for the incorrect package 112 instead of the correct package 111, the package monitor 134 can provide pickup guidance 136 to guide the pickup person 103 to reach for the package 111.

The pickup guidance 136 can include any combination of audible and visible guidance. The pickup guidance 136 can include, for example, illuminating the correct package 111 with a light, flashing a red or green light, presenting textual instructions on a display panel, broadcasting verbal instructions through a speaker, or broadcasting an alert sound through a speaker. In some examples, the instructions can provide information and/or instruct the pickup person 103 to perform actions. Example instructions include “look to your left,” “pick up the package on the right,” “the package is under the bench,” “pick up the brown cardboard box,” “you have picked up the wrong package,” “you have picked up the correct package,” etc.

The package monitor 134 can track multiple packages that are left for pickup from the property 102. As each package is left for pickup, the package monitor 134 can verify correct pickup of each package. The package monitor 134 can track each package and determine when each package is removed. When the package 111 is picked up, the package monitor 134 can send a pickup notification 138 to the mobile device 120 indicating that the package 111 has been removed. The package monitor 134 can send the notification to the mobile device 120, e.g., over a long-range data link. In some examples, the package monitor 134 can transmit a pickup notification 138 to more than one resident. For example, three residents may be associated with the property 102. The package monitor 134 can transmit the pickup notification 138 to each of the three residents.

Though described above as being performed by a particular component of a monitoring system (e.g., the camera 104 or the monitoring system 110), any of the various control, processing, or analysis operations, or a combination of these operations, can be performed by either the camera 104, or another component of the monitoring system 110. For example, the monitoring system 110 may include a control unit at the property 102. The control unit may be configured to monitor and control various sensors and devices at the property 102. The control unit may communicate with the camera 104 and other sensors over a wireless network at the property 102. The control unit, the monitoring system 110, the camera 104, or another computer system can analyze images 115, 116 to verify and monitor deliveries at the property 102.

FIG. 2 illustrates the example environment 100 in which monitoring system 110 can guard packages from pickup by unauthorized personnel using video. In the example of FIG. 2, a first image 205 shows two packages 211, 212 set out for delivery on the porch 108 at 7:30 am. A second image 216 shows a pickup person 203 approaching the property 102 at 12:00 pm. The pickup person 203 is driving an unmarked sedan 233 and is not wearing a uniform or a nametag.

The package monitor 134 performs a verification process and determines that the pickup person 203 is unverified 240. In some examples, the package monitor 134 can determine that the pickup person 203 is unverified 240 based on determining that the pickup person 203 does not satisfy any verification criteria. For example, the package monitor 134 may determine that the sedan 233 does not display any logo or business name that matches an assigned delivery service. The package monitor 134 may determine that the pickup person 203 is not wearing any uniform or nametag that corresponds to an assigned delivery service. The package monitor 134 may determine that the pickup person 203 does not provide an accurate password or code.

In some examples, the package monitor 134 can determine that the pickup person 203 is unverified 240 based on determining that the pickup person 203 satisfies fewer than a required number of verification criteria. For example, the required number of verification criteria may be two verification criteria. The pickup person 203 may satisfy a first verification criterion by arriving within the expected pickup time window, but might not satisfy any second criterion. Thus, due to the pickup person 203 not satisfying at least the required number of verification criteria, the package monitor 134 can determine that the pickup person 203 is unverified.

When the pickup person 203 approaches the property 102, the package monitor 134 can provide a warning 236 based on determining that the pickup person 203 is unverified 240. The warning 236 can include, for example, a verbal or visual prompt, e.g., challenge, presented through the signaling device 242. The prompt can include a request to provide a credential, e.g., by speaking the person's name, by speaking a password, or by presenting a visible code to the camera 104. If the pickup person 203 does not provide the requested credentials, the package monitor 134 can provide an additional warning 236, e.g., including a verbal or textual instruction. The instruction may state, for example, “put the package down.” If the pickup person 203 picks up one of the packages without being verified, the package monitor 134 can escalate the warning 236 to an alarm. The alarm can include, for example, a siren sound and/or a flashing light.

In addition to providing the warning 236 when an unverified person interferes with the packages, the package monitor 134 can provide an interference notification 238 to the resident 150, e.g., through the mobile device 120. The interference notification 238 can include information related to the pickup person 203, e.g., an image of the pickup person 203 and a time of arrival of the pickup person 203. The interference notification 238 can also indicate whether the pickup person 203 has removed the package 211, the package 212, or both.

In some examples, the monitoring system 110 can be integrated into a facility such as a mailroom for a residential or commercial building. In this example, each person who is leaving a package for pickup can present the package to a camera capable of recording the recipient, tracking number, and appearance of the package. The monitoring system 110 can store, for each package, a location where the package is left (e.g., a shelf or cubby number).

As each pickup person picks up the packages, the monitoring system 110 can use facial recognition or other means to identify the person, guide the person to the correct packages, and verify the person departs with the correct packages.

If a person picks up the wrong package, the system can audibly or visually provide instructions or warnings to the person. If the person proceeds to take the wrong package, the system can escalate the warnings to an alert, e.g., by broadcasting an audible alarm, flashing lights, and/or by shutting the door to the mailroom. In some examples, the monitoring system 110 can provide an interference notification to a door attendant or mailroom attendant.

In some examples, the system can provide instructions to the person to perform certain actions in order to provide confirmation that the person did pick up the correct package. For example, the system can provide instructions to the person to turn towards the camera in order to give the camera a better view of the delivery label or a better view of the person's face.

In some examples, the actions performed by the system can be based at least in part on confidence values. For example, for high confidence values, e.g., of 90% or greater that the person is authorized to pick up the package, the system might not perform additional confirmation actions. For intermediate confidence values, e.g., of between 50% and 90%, the system can perform additional confirmation actions, e.g., of instructing the person to turn towards the camera. For lower confidence values, e.g., of between 20% and 50%, the system can perform additional confirmation actions, e.g., of instructing the person to turn towards the camera and of requesting a credential to be provided by the person. For very low confidence values, e.g. of 20% or less, the system can perform warning actions to prevent the person from taking the package. In some examples, the system can determine what type of confirmation or credential would have the greatest impact on the confidence value, based on the weighting of data used to compute the aggregate confidence. The system can thus perform confirmation actions that are most likely to increase the confidence values.

The monitoring system 110 can also provide a notification to a person as the person enters the building or walks near the mailroom. The notification can indicate whether the person has packages to pick up from the mailroom.

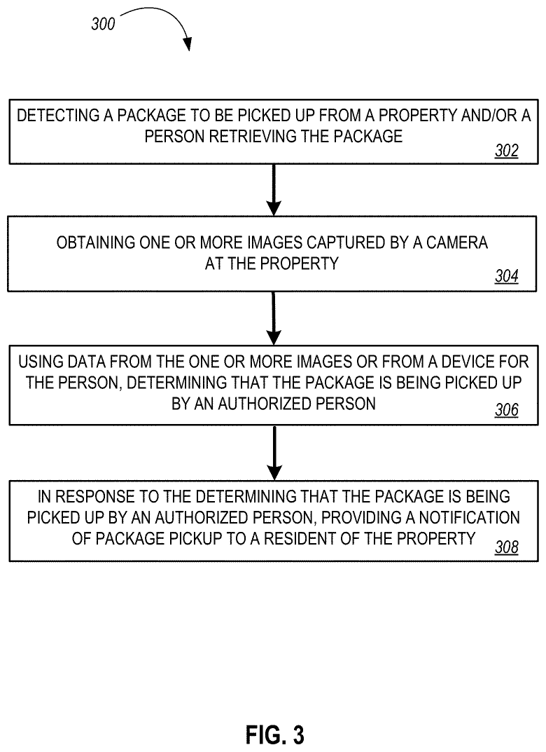

FIG. 3 is a flow diagram of an example process for verifying package pickups by authorized personnel. Briefly, the process 300 includes detecting a package to be picked up from a property and/or a person retrieving the package (302), obtaining one or more images captured by a camera at the property (304), using data from the one or more images or from a device for the person, determining that the package is being picked up by an authorized person (306), and in response to the determining that the package is being picked up by an authorize person, providing a notification of package pickup to a resident of the property (308).

In additional detail, the process 300 includes detecting a package to be picked up from a property and/or a person retrieving the package (302). For example, the package detector 130 detects the package 111 in the first image 115 and determines that the package 111 has been left on the porch 108 for pickup.

The process 300 includes obtaining one or more images captured by a camera at the property (304). For example, the monitoring system 110 obtains the second image 116 captured by the camera 104 at the property 102.

The process 300 includes, using data from the one or more images or from a device for the person, determining that the package is being picked up by an authorized person (306). For example, based on the second image 116, the package monitor 134 determines that the package 111 is being picked up by an authorized pickup person 103 and verifies 140 the pickup person 103.

The process 300 includes in response to the determining that the package is being picked up by an authorized person, providing a notification of package pickup to a resident of the property (308). For example, when the pickup person 103 picks up the package 111, the package monitor 134 provides the pickup notification 138 to the resident 150 via the mobile device 120.

The order of steps in the process 300 described above is illustrative only, and can be performed in different orders. For example, obtaining one or more images captured by a camera at the property (304) can occur before detecting a package to be picked up from a property and/or a person retrieving the package (302).

In some implementations, the process 300 can include additional steps, fewer steps, or some of the steps can be divided into multiple steps. For example, the obtaining one or more images captured by a camera at the property (304) and providing a notification of package pickup to a resident of the property (308) can be skipped.

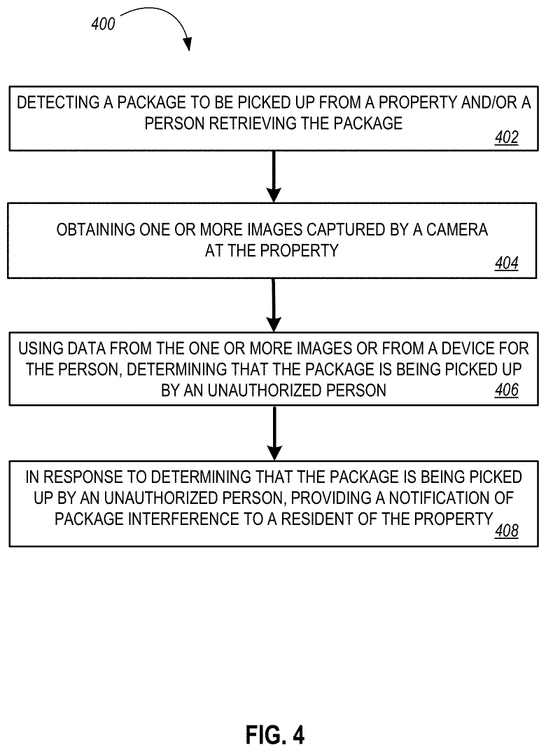

FIG. 4 is a flow diagram of an example process for guarding packages from pickup by unauthorized personnel. Briefly, the process 400 includes detecting a package to be picked up from a property and/or a person retrieving the package (402), obtaining one or more images captured by a camera at the property (404), using data from the one or more images or from a device for the person, determining that the package is being picked up by an unauthorized person (406), and in response to determining that the package is being picked up by an unauthorized person, providing a notification of package interference to a resident of the property (408).

In additional detail, the process 400 includes detecting a package to be picked up from a property and/or a person retrieving the package (402). For example, the package detector 130 detects the package 211 in the first image 215 and determines that the package 211 has been left for pickup from the property 102.

The process 400 includes obtaining one or more images captured by a camera at the property (404). For example, the monitoring system 110 obtains the second image 216 captured by the camera 104 at the property 102.

The process 400 includes, using data from the one or more images or from a device for the person, determining that the package is being picked up by an unauthorized person (406). For example, based on the second image 216, the package monitor 134 determines that the package 211 is being picked up by an unauthorized pickup person 203.

The process 400 includes in response to determining that the package is being picked up by an unauthorized person, providing a notification of package interference to a resident of the property (408). For example, in response to determining that the package 211 is being picked up by an unauthorized pickup person 203, the package monitor 134 sends an interference notification 238 to the resident 150 via the mobile device 120.

The order of steps in the process 400 described above is illustrative only, and can be performed in different orders. For example, obtaining one or more images captured by a camera at the property (404) can occur before detecting a package to be picked up from a property and/or a person retrieving the package (402).

In some implementations, the process 400 can include additional steps, fewer steps, or some of the steps can be divided into multiple steps. For example, obtaining one or more images captured by a camera at the property (404), and providing a notification of package interference to a resident of the property (408) can be skipped.

In some examples, instead of the delivery person, a package can be delivered or retrieved by a robot. The monitoring system 110 can coordinate with the robot to provide data about the packages to be picked up or dropped off. The data can include, but is not limited to, models, images, scans, extracted image features, location of the package, orientation of the package, or a combination of these. The monitoring system 110 and the robot can coordinate imagery taken from different angles to confirm the correct package for pickup or drop off. The robot can manipulate the package to rotate it and provide a better viewing angle for the camera of the robot or the cameras of the property 102. The monitoring system 110 can perform additional analysis on the imagery in order to verify the correct package.

The monitoring system 110 can transmit data to the robot about the environment. The data can include 3D or 2D models of the area, significant landmarks, visual landmarks, locations of packages, designate drop off or pickup locations, the location of obstacles, or a combination of these. In some instances, the robot can use data from the sensors of the property 102 in order to determine where the robot is located with respect to the property 102, the package, or both.

The monitoring system 110 can interact with the robot using one or more signals that are not detectable using human senses. For example, the monitoring system 110 can illuminate packages for pickup or designate areas for drop off using infrared light. The monitoring system 110 can establish communications directly with the robot and provide data that assists in the navigation and pickup or drop off of the packages.

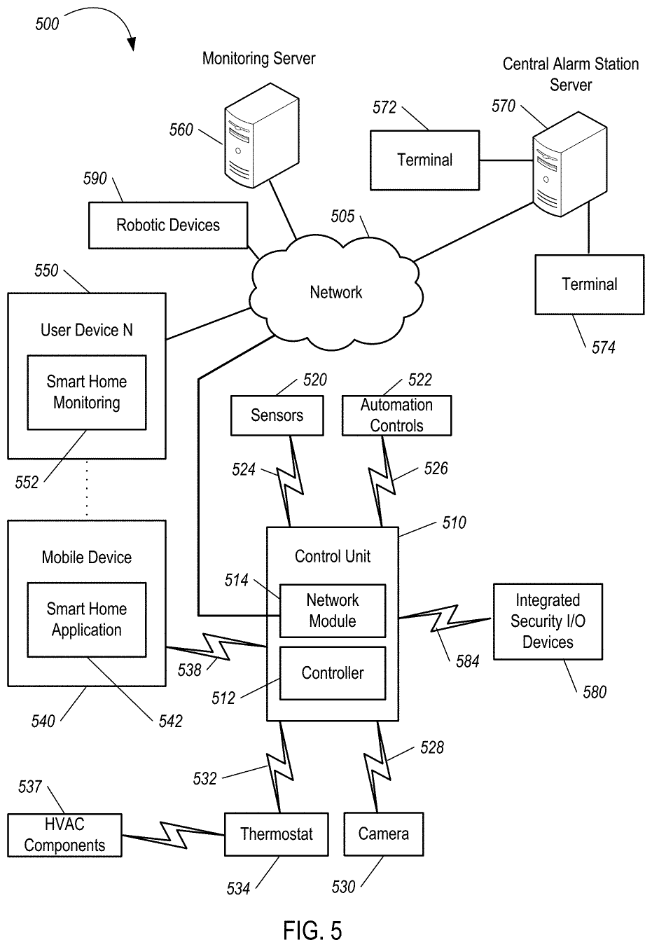

FIG. 5 is a diagram illustrating an example of a home monitoring system 500. The monitoring system 500 includes a network 505, a control unit 510, one or more user devices 540 and 550, a monitoring system 560, and a central alarm station server 570. In some examples, the network 505 facilitates communications between the control unit 510, the one or more user devices 540 and 550, the monitoring system 560, and the central alarm station server 570. The system 500 can include the monitoring server 110. For example, in some implementations, the camera 530 of the system 500 may be the camera 104, and the monitoring system 560 may be the monitoring system 110. The automation controls 522 may be connected to the signaling device 142. The mobile device 540 may be the mobile device 120.

The network 505 is configured to enable exchange of electronic communications between devices connected to the network 505. For example, the network 505 may be configured to enable exchange of electronic communications between the control unit 510, the one or more user devices 540 and 550, the monitoring system 560, and the central alarm station server 570. The network 505 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other pickup or tunneling mechanism for carrying data. Network 505 may include multiple networks or subnetworks, each of which may include, for example, a wired or wireless data pathway. The network 505 may include a circuit-switched network, a packet-switched data network, or any other network able to carry electronic communications (e.g., data or voice communications). For example, the network 505 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 505 may include one or more networks that include wireless data channels and wireless voice channels. The network 505 may be a wireless network, a broadband network, or a combination of networks including a wireless network and a broadband network.

The control unit 510 includes a controller 512 and a network module 514. The controller 512 is configured to control a control unit monitoring system (e.g., a control unit system) that includes the control unit 510. In some examples, the controller 512 may include a processor or other control circuitry configured to execute instructions of a program that controls operation of a control unit system. In these examples, the controller 512 may be configured to receive input from sensors, flow meters, or other devices included in the control unit system and control operations of devices included in the household (e.g., speakers, lights, doors, etc.). For example, the controller 512 may be configured to control operation of the network module 514 included in the control unit 510.

The network module 514 is a communication device configured to exchange communications over the network 505. The network module 514 may be a wireless communication module configured to exchange wireless communications over the network 505. For example, the network module 514 may be a wireless communication device configured to exchange communications over a wireless data channel and a wireless voice channel. In this example, the network module 514 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 514 also may be a wired communication module configured to exchange communications over the network 505 using a wired connection. For instance, the network module 514 may be a modem, a network interface card, or another type of network interface device. The network module 514 may be an Ethernet network card configured to enable the control unit 510 to communicate over a local area network and/or the Internet. The network module 514 also may be a voice band modem configured to enable the alarm panel to communicate over the telephone lines of Plain Old Telephone Systems (POTS).

The control unit system that includes the control unit 510 includes one or more sensors. For example, the monitoring system may include multiple sensors 520. The sensors 520 may include a lock sensor, a contact sensor, a motion sensor, or any other type of sensor included in a control unit system. The sensors 520 also may include an environmental sensor, such as a temperature sensor, a water sensor, a rain sensor, a wind sensor, a light sensor, a smoke detector, a carbon monoxide detector, an air quality sensor, etc. The sensors 520 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health-monitoring sensor can be a wearable sensor that attaches to a user in the home. The health-monitoring sensor can collect various health data, including pulse, heart rate, respiration rate, sugar or glucose level, bodily temperature, or motion data.

The sensors 520 can also include a radio-frequency identification (RFID) sensor that identifies a particular article that includes a pre-assigned RFID tag.

The control unit 510 communicates with the home automation controls 522 and a camera 530 to perform monitoring. The home automation controls 522 are connected to one or more devices that enable automation of actions in the home. For instance, the home automation controls 522 may be connected to one or more lighting systems and may be configured to control operation of the one or more lighting systems. In addition, the home automation controls 522 may be connected to one or more electronic locks at the home and may be configured to control operation of the one or more electronic locks (e.g., control Z-Wave locks using wireless communications in the Z-Wave protocol). Further, the home automation controls 522 may be connected to one or more appliances at the home and may be configured to control operation of the one or more appliances. The home automation controls 522 may include multiple modules that are each specific to the type of device being controlled in an automated manner. The home automation controls 522 may control the one or more devices based on commands received from the control unit 510. For instance, the home automation controls 522 may cause a lighting system to illuminate an area to provide a better image of the area when captured by a camera 530.

The camera 530 may be a video/photographic camera or other type of optical sensing device configured to capture images. For instance, the camera 530 may be configured to capture images of an area within a building or home monitored by the control unit 510. The camera 530 may be configured to capture single, static images of the area and also video images of the area in which multiple images of the area are captured at a relatively high frequency (e.g., thirty images per second). The camera 530 may be controlled based on commands received from the control unit 510.

The camera 530 may be triggered by several different types of techniques. For instance, a Passive Infra-Red (PIR) motion sensor may be built into the camera 530 and used to trigger the camera 530 to capture one or more images when motion is detected. The camera 530 also may include a microwave motion sensor built into the camera and used to trigger the camera 530 to capture one or more images when motion is detected. The camera 530 may have a “normally open” or “normally closed” digital input that can trigger capture of one or more images when external sensors (e.g., the sensors 520, PIR, door/window, etc.) detect motion or other events. In some implementations, the camera 530 receives a command to capture an image when external devices detect motion or another potential alarm event. The camera 530 may receive the command from the controller 512 or directly from one of the sensors 520.

In some examples, the camera 530 triggers integrated or external illuminators (e.g., Infra-Red, Z-wave controlled “white” lights, lights controlled by the home automation controls 522, etc.) to improve image quality when the scene is dark. An integrated or separate light sensor may be used to determine if illumination is desired and may result in increased image quality.

The camera 530 may be programmed with any combination of time/day schedules, system “arming state”, or other variables to determine whether images should be captured or not when triggers occur. The camera 530 may enter a low-power mode when not capturing images. In this case, the camera 530 may wake periodically to check for inbound messages from the controller 512. The camera 530 may be powered by internal, replaceable batteries if located remotely from the control unit 510. The camera 530 may employ a small solar cell to recharge the battery when light is available. Alternatively, the camera 530 may be powered by the controller's 512 power supply if the camera 530 is co-located with the controller 512.

In some implementations, the camera 530 communicates directly with the monitoring system 560 over the Internet. In these implementations, image data captured by the camera 530 does not pass through the control unit 510 and the camera 530 receives commands related to operation from the monitoring system 560.

The system 500 also includes thermostat 534 to perform dynamic environmental control at the home. The thermostat 534 is configured to monitor temperature and/or energy consumption of an HVAC system associated with the thermostat 534, and is further configured to provide control of environmental (e.g., temperature) settings. In some implementations, the thermostat 534 can additionally or alternatively receive data relating to activity at a home and/or environmental data at a home, e.g., at various locations indoors and outdoors at the home. The thermostat 534 can directly measure energy consumption of the HVAC system associated with the thermostat, or can estimate energy consumption of the HVAC system associated with the thermostat 534, for example, based on detected usage of one or more components of the HVAC system associated with the thermostat 534. The thermostat 534 can communicate temperature and/or energy monitoring information to or from the control unit 510 and can control the environmental (e.g., temperature) settings based on commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In addition, the control unit 510 can be a gateway device that communicates with the dynamically programmable thermostat 534. In some implementations, the thermostat 534 is controlled via one or more home automation controls 522.

A module 537 is connected to one or more components of an HVAC system associated with a home, and is configured to control operation of the one or more components of the HVAC system. In some implementations, the module 537 is also configured to monitor energy consumption of the HVAC system components, for example, by directly measuring the energy consumption of the HVAC system components or by estimating the energy usage of the one or more HVAC system components based on detecting usage of components of the HVAC system. The module 537 can communicate energy monitoring information and the state of the HVAC system components to the thermostat 534 and can control the one or more components of the HVAC system based on commands received from the thermostat 534.

In some examples, the system 500 further includes one or more robotic devices 590. The robotic devices 590 may be any type of robots that are capable of moving and taking actions that assist in home monitoring. For example, the robotic devices 590 may include drones that are capable of moving throughout a home based on automated control technology and/or user input control provided by a user. In this example, the drones may be able to fly, roll, walk, or otherwise move about the home. The drones may include helicopter type devices (e.g., quad copters), rolling helicopter type devices (e.g., roller copter devices that can fly and roll along the ground, walls, or ceiling) and land vehicle type devices (e.g., automated cars that drive around a home). In some cases, the robotic devices 590 may be devices that are intended for other purposes and merely associated with the system 500 for use in appropriate circumstances. For instance, a robotic vacuum cleaner device may be associated with the monitoring system 500 as one of the robotic devices 590 and may be controlled to take action responsive to monitoring system events.

In some examples, the robotic devices 590 automatically navigate within a home. In these examples, the robotic devices 590 include sensors and control processors that guide movement of the robotic devices 590 within the home. For instance, the robotic devices 590 may navigate within the home using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 590 may include control processors that process output from the various sensors and control the robotic devices 590 to move along a path that reaches the desired destination and avoids obstacles. In this regard, the control processors detect walls or other obstacles in the home and guide movement of the robotic devices 590 in a manner that avoids the walls and other obstacles.

In addition, the robotic devices 590 may store data that describes attributes of the home. For instance, the robotic devices 590 may store a floorplan and/or a three-dimensional model of the home that enables the robotic devices 590 to navigate the home. During initial configuration, the robotic devices 590 may receive the data describing attributes of the home, determine a frame of reference to the data (e.g., a home or reference location in the home), and navigate the home based on the frame of reference and the data describing attributes of the home. Further, initial configuration of the robotic devices 590 also may include learning of one or more navigation patterns in which a user provides input to control the robotic devices 590 to perform a specific navigation action (e.g., fly to an upstairs bedroom and spin around while capturing video and then return to a home charging base). In this regard, the robotic devices 590 may learn and store the navigation patterns such that the robotic devices 590 may automatically repeat the specific navigation actions upon a later request.

In some examples, the robotic devices 590 may include data capture and recording devices. In these examples, the robotic devices 590 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the home and users in the home. The one or more biometric data collection tools may be configured to collect biometric samples of a person in the home with or without contact of the person. For instance, the biometric data collection tools may include a fingerprint scanner, a hair sample collection tool, a skin cell collection tool, and/or any other tool that allows the robotic devices 590 to take and store a biometric sample that can be used to identify the person (e.g., a biometric sample with DNA that can be used for DNA testing).

In some implementations, the robotic devices 590 may include output devices. In these implementations, the robotic devices 590 may include one or more displays, one or more speakers, and/or any type of output devices that allow the robotic devices 590 to communicate information to a nearby user.

The robotic devices 590 also may include a communication module that enables the robotic devices 590 to communicate with the control unit 510, each other, and/or other devices. The communication module may be a wireless communication module that allows the robotic devices 590 to communicate wirelessly. For instance, the communication module may be a Wi-Fi module that enables the robotic devices 590 to communicate over a local wireless network at the home. The communication module further may be a 900 MHz wireless communication module that enables the robotic devices 590 to communicate directly with the control unit 510. Other types of short-range wireless communication protocols, such as Bluetooth, Bluetooth LE, Z-wave, Zigbee, etc., may be used to allow the robotic devices 590 to communicate with other devices in the home. In some implementations, the robotic devices 590 may communicate with each other or with other devices of the system 500 through the network 505.

The robotic devices 590 further may include processor and storage capabilities. The robotic devices 590 may include any suitable processing devices that enable the robotic devices 590 to operate applications and perform the actions described throughout this disclosure. In addition, the robotic devices 590 may include solid-state electronic storage that enables the robotic devices 590 to store applications, configuration data, collected sensor data, and/or any other type of information available to the robotic devices 590.

The robotic devices 590 are associated with one or more charging stations. The charging stations may be located at predefined home base or reference locations in the home. The robotic devices 590 may be configured to navigate to the charging stations after completion of tasks needed to be performed for the monitoring system 500. For instance, after completion of a monitoring operation or upon instruction by the control unit 510, the robotic devices 590 may be configured to automatically fly to and land on one of the charging stations. In this regard, the robotic devices 590 may automatically maintain a fully charged battery in a state in which the robotic devices 590 are ready for use by the monitoring system 500.

The charging stations may be contact based charging stations and/or wireless charging stations. For contact based charging stations, the robotic devices 590 may have readily accessible points of contact that the robotic devices 590 are capable of positioning and mating with a corresponding contact on the charging station. For instance, a helicopter type robotic device may have an electronic contact on a portion of its landing gear that rests on and mates with an electronic pad of a charging station when the helicopter type robotic device lands on the charging station. The electronic contact on the robotic device may include a cover that opens to expose the electronic contact when the robotic device is charging and closes to cover and insulate the electronic contact when the robotic device is in operation.

For wireless charging stations, the robotic devices 590 may charge through a wireless exchange of power. In these cases, the robotic devices 590 need only locate themselves closely enough to the wireless charging stations for the wireless exchange of power to occur. In this regard, the positioning needed to land at a predefined home base or reference location in the home may be less precise than with a contact based charging station. Based on the robotic devices 590 landing at a wireless charging station, the wireless charging station outputs a wireless signal that the robotic devices 590 receive and convert to a power signal that charges a battery maintained on the robotic devices 590.

In some implementations, each of the robotic devices 590 has a corresponding and assigned charging station such that the number of robotic devices 590 equals the number of charging stations. In these implementations, the robotic devices 590 always navigate to the specific charging station assigned to that robotic device. For instance, a first robotic device may always use a first charging station and a second robotic device may always use a second charging station.

In some examples, the robotic devices 590 may share charging stations. For instance, the robotic devices 590 may use one or more community charging stations that are capable of charging multiple robotic devices 590. The community charging station may be configured to charge multiple robotic devices 590 in parallel. The community charging station may be configured to charge multiple robotic devices 590 in serial such that the multiple robotic devices 590 take turns charging and, when fully charged, return to a predefined home base or reference location in the home that is not associated with a charger. The number of community charging stations may be less than the number of robotic devices 590.

In addition, the charging stations may not be assigned to specific robotic devices 590 and may be capable of charging any of the robotic devices 590. In this regard, the robotic devices 590 may use any suitable, unoccupied charging station when not in use. For instance, when one of the robotic devices 590 has completed an operation or is in need of battery charge, the control unit 510 references a stored table of the occupancy status of each charging station and instructs the robotic device to navigate to the nearest charging station that is unoccupied.

The system 500 further includes one or more integrated security devices 580. The one or more integrated security devices may include any type of device used to provide alerts based on received sensor data. For instance, the one or more control units 510 may provide one or more alerts to the one or more integrated security input/output devices 580. Additionally, the one or more control units 510 may receive one or more sensor data from the sensors 520 and determine whether to provide an alert to the one or more integrated security input/output devices 580.

The sensors 520, the home automation controls 522, the camera 530, the thermostat 534, and the integrated security devices 580 may communicate with the controller 512 over communication links 524, 526, 528, 532, 538, and 584. The communication links 524, 526, 528, 532, 538, and 584 may be a wired or wireless data pathway configured to transmit signals from the sensors 520, the home automation controls 522, the camera 530, the thermostat 534, and the integrated security devices 580 to the controller 512. The sensors 520, the home automation controls 522, the camera 530, the thermostat 534, and the integrated security devices 580 may continuously transmit sensed values to the controller 512, periodically transmit sensed values to the controller 512, or transmit sensed values to the controller 512 in response to a change in a sensed value.

The communication links 524, 526, 528, 532, 538, and 584 may include a local network. The sensors 520, the home automation controls 522, the camera 530, the thermostat 534, and the integrated security devices 580, and the controller 512 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring system 560 is an electronic device configured to provide monitoring services by exchanging electronic communications with the control unit 510, the one or more user devices 540 and 550, and the central alarm station server 570 over the network 505. For example, the monitoring system 560 may be configured to monitor events generated by the control unit 510. In this example, the monitoring system 560 may exchange electronic communications with the network module 514 included in the control unit 510 to receive information regarding events detected by the control unit 510. The monitoring system 560 also may receive information regarding events from the one or more user devices 540 and 550.

In some examples, the monitoring system 560 may route alert data received from the network module 514 or the one or more user devices 540 and 550 to the central alarm station server 570. For example, the monitoring system 560 may transmit the alert data to the central alarm station server 570 over the network 505.

The monitoring system 560 may store sensor and image data received from the monitoring system and perform analysis of sensor and image data received from the monitoring system. Based on the analysis, the monitoring system 560 may communicate with and control aspects of the control unit 510 or the one or more user devices 540 and 550.

The monitoring system 560 may provide various monitoring services to the system 500. For example, the monitoring system 560 may analyze the sensor, image, and other data to determine an activity pattern of a resident of the home monitored by the system 500. In some implementations, the monitoring system 560 may analyze the data for alarm conditions or may determine and perform actions at the home by issuing commands to one or more of the controls 522, possibly through the control unit 510.

The monitoring system 560 can be configured to provide information (e.g., activity patterns) related to one or more residents of the home monitored by the system 500 (e.g., resident 150). For example, one or more of the sensors 520, the home automation controls 522, the camera 530, the thermostat 534, and the integrated security devices 580 can collect data related to a resident including location information (e.g., if the resident is home or is not home) and provide location information to the thermostat 534.

The central alarm station server 570 is an electronic device configured to provide alarm monitoring service by exchanging communications with the control unit 510, the one or more user devices 540 and 550, and the monitoring system 560 over the network 505. For example, the central alarm station server 570 may be configured to monitor alerting events generated by the control unit 510. In this example, the central alarm station server 570 may exchange communications with the network module 514 included in the control unit 510 to receive information regarding alerting events detected by the control unit 510. The central alarm station server 570 also may receive information regarding alerting events from the one or more user devices 540 and 550 and/or the monitoring system 560.

The central alarm station server 570 is connected to multiple terminals 572 and 574. The terminals 572 and 574 may be used by operators to process alerting events. For example, the central alarm station server 570 may route alerting data to the terminals 572 and 574 to enable an operator to process the alerting data. The terminals 572 and 574 may include general-purpose computers (e.g., desktop personal computers, workstations, or laptop computers) that are configured to receive alerting data from a server in the central alarm station server 570 and render a display of information based on the alerting data. For instance, the controller 512 may control the network module 514 to transmit, to the central alarm station server 570, alerting data indicating that a sensor 520 detected motion from a motion sensor via the sensors 520. The central alarm station server 570 may receive the alerting data and route the alerting data to the terminal 572 for processing by an operator associated with the terminal 572. The terminal 572 may render a display to the operator that includes information associated with the alerting event (e.g., the lock sensor data, the motion sensor data, the contact sensor data, etc.) and the operator may handle the alerting event based on the displayed information.

In some implementations, the terminals 572 and 574 may be mobile devices or devices designed for a specific function. Although FIG. 5 illustrates two terminals for brevity, actual implementations may include more (and, perhaps, many more) terminals.

The one or more authorized user devices 540 and 550 are devices that host and display user interfaces. For instance, the user device 540 is a mobile device that hosts or runs one or more native applications (e.g., the home monitoring application 542). The user device 540 may be a cellular phone or a non-cellular locally networked device with a display. The user device 540 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 540 may perform functions unrelated to the monitoring system, such as placing personal telephone calls, playing music, playing video, displaying pictures, browsing the Internet, maintaining an electronic calendar, etc.

The user device 540 includes a home monitoring application 552. The home monitoring application 542 refers to a software/firmware program running on the corresponding mobile device that enables the user interface and features described throughout. The user device 540 may load or install the home monitoring application 542 based on data received over a network or data received from local media. The home monitoring application 542 runs on mobile devices platforms, such as iPhone, iPod touch, Blackberry, Google Android, Windows Mobile, etc. The home monitoring application 542 enables the user device 540 to receive and process image and sensor data from the monitoring system.

The user device 540 may be a general-purpose computer (e.g., a desktop personal computer, a workstation, or a laptop computer) that is configured to communicate with the monitoring system 560 and/or the control unit 510 over the network 505. The user device 540 may be configured to display a smart home user interface 552 that is generated by the user device 540 or generated by the monitoring system 560. For example, the user device 540 may be configured to display a user interface (e.g., a web page) provided by the monitoring system 560 that enables a user to perceive images captured by the camera 530 and/or reports related to the monitoring system. Although FIG. 5 illustrates two user devices for brevity, actual implementations may include more (and, perhaps, many more) or fewer user devices.

In some implementations, the one or more user devices 540 and 550 communicate with and receive monitoring system data from the control unit 510 using the communication link 538. For instance, the one or more user devices 540 and 550 may communicate with the control unit 510 using various local wireless protocols such as Wi-Fi, Bluetooth, Z-wave, Zigbee, HomePlug (ethernet over power line), or wired protocols such as Ethernet and USB, to connect the one or more user devices 540 and 550 to local security and automation equipment. The one or more user devices 540 and 550 may connect locally to the monitoring system and its sensors and other devices. The local connection may improve the speed of status and control communications because communicating through the network 505 with a remote server (e.g., the monitoring system 560) may be significantly slower.

Although the one or more user devices 540 and 550 are shown as communicating with the control unit 510, the one or more user devices 540 and 550 may communicate directly with the sensors and other devices controlled by the control unit 510. In some implementations, the one or more user devices 540 and 550 replace the control unit 510 and perform the functions of the control unit 510 for local monitoring and long range/offsite communication.

In other implementations, the one or more user devices 540 and 550 receive monitoring system data captured by the control unit 510 through the network 505. The one or more user devices 540, 550 may receive the data from the control unit 510 through the network 505 or the monitoring system 560 may relay data received from the control unit 510 to the one or more user devices 540 and 550 through the network 505. In this regard, the monitoring system 560 may facilitate communication between the one or more user devices 540 and 550 and the monitoring system.

In some implementations, the one or more user devices 540 and 550 may be configured to switch whether the one or more user devices 540 and 550 communicate with the control unit 510 directly (e.g., through link 538) or through the monitoring system 560 (e.g., through network 505) based on a location of the one or more user devices 540 and 550. For instance, when the one or more user devices 540 and 550 are located close to the control unit 510 and in range to communicate directly with the control unit 510, the one or more user devices 540 and 550 use direct communication. When the one or more user devices 540 and 550 are located far from the control unit 510 and not in range to communicate directly with the control unit 510, the one or more user devices 540 and 550 use communication through the monitoring system 560.

Although the one or more user devices 540 and 550 are shown as being connected to the network 505, in some implementations, the one or more user devices 540 and 550 are not connected to the network 505. In these implementations, the one or more user devices 540 and 550 communicate directly with one or more of the monitoring system components and no network (e.g., Internet) connection or reliance on remote servers is needed.

In some implementations, the one or more user devices 540 and 550 are used in conjunction with only local sensors and/or local devices in a house. In these implementations, the system 500 includes the one or more user devices 540 and 550, the sensors 520, the home automation controls 522, the camera 530, and the robotic devices 590. The one or more user devices 540 and 550 receive data directly from the sensors 520, the home automation controls 522, the camera 530, and the robotic devices 590, and sends data directly to the sensors 520, the home automation controls 522, the camera 530, and the robotic devices 590. The one or more user devices 540, 550 provide the appropriate interfaces/processing to provide visual surveillance and reporting.

In other implementations, the system 500 further includes network 505 and the sensors 520, the home automation controls 522, the camera 530, the thermostat 534, and the robotic devices 590, and are configured to communicate sensor and image data to the one or more user devices 540 and 550 over network 505 (e.g., the Internet, cellular network, etc.). In yet another implementation, the sensors 520, the home automation controls 522, the camera 530, the thermostat 534, and the robotic devices 590 (or a component, such as a bridge/router) are intelligent enough to change the communication pathway from a direct local pathway when the one or more user devices 540 and 550 are in close physical proximity to the sensors 520, the home automation controls 522, the camera 530, the thermostat 534, and the robotic devices 590 to a pathway over network 505 when the one or more user devices 540 and 550 are farther from the sensors 520, the home automation controls 522, the camera 530, the thermostat 534, and the robotic devices 590.

In some examples, the system leverages GPS information from the one or more user devices 540 and 550 to determine whether the one or more user devices 540 and 550 are close enough to the sensors 520, the home automation controls 522, the camera 530, the thermostat 534, and the robotic devices 590 to use the direct local pathway or whether the one or more user devices 540 and 550 are far enough from the sensors 520, the home automation controls 522, the camera 530, the thermostat 534, and the robotic devices 590 that the pathway over network 505 is required.

In other examples, the system leverages status communications (e.g., pinging) between the one or more user devices 540 and 550 and the sensors 520, the home automation controls 522, the camera 530, the thermostat 534, and the robotic devices 590 to determine whether communication using the direct local pathway is possible. If communication using the direct local pathway is possible, the one or more user devices 540 and 550 communicate with the sensors 520, the home automation controls 522, the camera 530, the thermostat 534, and the robotic devices 590 using the direct local pathway. If communication using the direct local pathway is not possible, the one or more user devices 540 and 550 communicate with the sensors 520, the home automation controls 522, the camera 530, the thermostat 534, and the robotic devices 590 using the pathway over network 505.

In some implementations, the system 500 provides end users with access to images captured by the camera 530 to aid in decision making. The system 500 may transmit the images captured by the camera 530 over a wireless WAN network to the user devices 540 and 550. Because transmission over a wireless WAN network may be relatively expensive, the system 500 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the camera 530). In these implementations, the camera 530 may be set to capture images on a periodic basis when the alarm system is armed in an “away” state, but set not to capture images when the alarm system is armed in a “home” state or disarmed. In addition, the camera 530 may be triggered to begin capturing images when the alarm system detects an event, such as an alarm event, a door-opening event for a door that leads to an area within a field of view of the camera 530, or motion in the area within the field of view of the camera 530. In other implementations, the camera 530 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device.

Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A computer-implemented method comprising:
for an image that depicts a package at a property and a person retrieving the package, determining, using data from the image or from a device for the person, whether the person is authorized to retrieve the package; and
in response to determining that the person is authorized to retrieve the package, determining to skip performing an automated action that would have been performed if the person was not authorized to retrieve the package.

2. The method of claim 1, wherein determining, using the data from the image or from the device for the person, whether the person is authorized to retrieve the package comprises:
determining, using the data form the image, that the person is potentially not authorized to retrieve the package;
in response to determining, using the data form the image, that the person is potentially not authorized to retrieve the package, presenting a prompt for the person to provide information indicating that they are authorized to retrieve the package;
in response to presenting the prompt for the person, determining a response to the prompt; and
determining, using the response to the prompt, whether the person is authorized to retrieve the package.

3. The method of claim 2, wherein:
presenting the prompt comprises sending an instruction to another device installed at the property to cause the other device to present the prompt; and
determining the response to the prompt comprises:
capturing, with a microphone or a camera, sensor data that indicates the response to the prompt; and
analyzing the sensor data to determine the response to the prompt.

4. The method of claim 2, wherein:
presenting the prompt comprises sending an instruction to the device for the person to cause the device to present the prompt; and
determining the response to the prompt comprises receiving, from the device for the person, the response to the prompt.

5. The method of claim 2, wherein:
presenting the prompt comprises presenting the prompt for at least one of a visual credential or a verbal passphrase; and
determining the response to the prompt comprises receiving sensor data encoding at least one of the visual credential or the verbal passphrase.

6. The method of claim 1, wherein determining, using the data from the image or from the device for the person, whether the person is authorized to retrieve the package comprises:
recognizing, using the data from the image, an identifying mark on the person or a vehicle for the person came; and
in response to recognizing the identifying mark on the person or a vehicle for the person came, determining that the person is authorized to retrieve the package.

7. The method of claim 6, wherein the identifying mark comprises at least one of a uniform, a logo, a company name, or a badge.

8. The method of claim 1, wherein determining, using the data from the image or from the device for the person, whether the person is authorized to retrieve the package comprises:
in response to detecting a depiction of the person in the image, sending, to the device for the person, a request for data relating to an authorization of the person retrieving the package; and
determining, using a response or an indication that no response was received, whether the person is authorized to retrieve the package.

9. The method of claim 8, wherein the device for the person comprises a pickup vehicle, a handheld device, or a badge for the person.

10. The method of claim 1, wherein determining, using the data from the image or from the device for the person, whether the person is authorized to retrieve the package comprises determining, using a) package data for the package and b) the data from the image or from the device for the person, whether the person is authorized to retrieve the package.

11. The method of claim 1, wherein determining, using the data from the image or from the device for the person, whether the person is authorized to retrieve the package uses security data for the package.

12. The method of claim 1, wherein determining to skip performing the automated action that would have been performed if the person was not authorized to retrieve the package comprises determining to skip one or more confirmation actions to increase a confidence that the person was not authorized to retrieve the package.

13. The method of claim 12, wherein determining to skip the one or more confirmation actions comprises determining to skip sending a message to a device for an authorized person that prompts the authorized person to perform an action.

14. The method of claim 1, wherein determining, using data from the image or from a device for the person, whether the person is authorized to retrieve the package comprises:
determining, using the data from the image or from the device for the person, a confidence level that indicates a likelihood that the person is authorized to retrieve the package; and
determining whether the confidence level satisfies a confidence threshold.

15. The method of claim 1, comprising:
determining, using data from a second image or from a device for the person, whether the person will likely retrieve the package for which the person is authorized to retrieve from two or more packages at the property; and
in response to determining that the person will likely retrieve the package, determining to skip performing an automated action that would have been performed if the person was likely to retrieve another package for which the person is not authorized to retrieve from the two or more packages at the property.

16. A system comprising one or more computers and one or more storage devices on which are stored instructions that are operable, when executed by the one or more computers, to cause the one or more computers to perform operations comprising:
for an image that depicts a package at a property and a person retrieving the package, determining, using data from the image or from a device for the person, whether the person is authorized to retrieve the package; and
in response to determining that the person is authorized to retrieve the package, determining to skip performing an automated action that would have been performed if the person was not authorized to retrieve the package.

17. The system of claim 16, wherein determining, using the data from the image or from the device for the person, whether the person is authorized to retrieve the package comprises:
determining, using the data form the image, that the person is potentially not authorized to retrieve the package;
in response to determining, using the data form the image, that the person is potentially not authorized to retrieve the package, presenting a prompt for the person to provide information indicating that they are authorized to retrieve the package;
in response to presenting the prompt for the person, determining a response to the prompt; and
determining, using the response to the prompt, whether the person is authorized to retrieve the package.

18. The system of claim 17, wherein:
presenting the prompt comprises sending an instruction to another device installed at the property to cause the other device to present the prompt; and
determining the response to the prompt comprises:
capturing, with a microphone or a camera, sensor data that indicates the response to the prompt; and
analyzing the sensor data to determine the response to the prompt.

19. One or more non-transitory computer storage media encoded with instructions that, when executed by one or more computers, cause the one or more computers to perform operations comprising:
for an image that depicts a package at a property and a person retrieving the package, determining, using data from the image or from a device for the person, whether the person is authorized to retrieve the package; and
in response to determining that the person is authorized to retrieve the package, determining to skip performing an automated action that would have been performed if the person was not authorized to retrieve the package.

20. The computer storage medium of claim 19, wherein determining, using the data from the image or from the device for the person, whether the person is authorized to retrieve the package comprises:
determining, using the data form the image, that the person is potentially not authorized to retrieve the package;
in response to determining, using the data form the image, that the person is potentially not authorized to retrieve the package, presenting a prompt for the person to provide information indicating that they are authorized to retrieve the package;
in response to presenting the prompt for the person, determining a response to the prompt; and
determining, using the response to the prompt, whether the person is authorized to retrieve the package.
